(19) United States
(12) Patent Application Publication
(10) Pub. No.: US 2019/0317880 A1
(43) Pub. Date: Oct. 17, 2019

(54) METHODS AND APPARATUS TO IMPROVE RUNTIME PERFORMANCE OF SOFTWARE EXECUTING ON A HETEROGENEOUS SYSTEM

(71) Applicant: Intel Corporation, Santa Clara, CA (US)

(72) Inventors: Adam Herr, Forest Grove, OR (US); Sridhar Sharma, Palo Alto, CA (US); Mikael Bourges-Sevenier, Santa Clara, CA (US); Derek Gerstmann, San Diego, CA (US); Justin Gottschlich, Santa Clara, CA (US)

(21) Appl. No.: 16/455,486

(22) Filed: Jun. 27, 2019

(51) Int. Cl. G06F 11/36; G06N 20/00

(52) U.S. Cl. CPC G06F 11/3612; G06N 20/00; G06F 11/3608

(57) ABSTRACT

Methods, apparatus, systems and articles of manufacture are disclosed improve runtime performance of software executing on a heterogeneous system. An example apparatus includes a feedback interface to collect a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element; a performance analyzer to determine a performance delta based on the performance characteristic and the function; and a machine learning modeler to, prior to a second runtime, adjust a cost model of the first processing element based on the performance delta, the adjusted cost model to cause a reduction in the performance delta to improve runtime performance of the heterogeneous system.

### FIELD OF THE DISCLOSURE

This disclosure relates generally to processing, and, more particularly, to methods and apparatus to improve runtime performance of software executing on a heterogeneous system.

### BACKGROUND

Computer hardware manufacturers develop hardware components for use in various components of a computer platform. For example, computer hardware manufacturers develop motherboards, chipsets for motherboards, central processing units (CPUs), graphics processing units (GPUs), vision processing units (VPUs), field programmable gate arrays (FPGAs), hard disk drives (HDDs), solid state drives (SSDs), and other computer components. Many computer hardware manufacturers develop programs and/or other methods to compile algorithms and/or other code to be run on a specific processing platform.

### BRIEF DESCRIPTION OF THE DRAWINGS

FIG. 1 is a block diagram illustrating an example heterogeneous system.

FIG. 2 is a block diagram illustrating an example network including a first software adjustment system to train an example machine learning/artificial intelligence model and a second software adjustment system.

FIG. 3 is a block diagram illustrating an example software adjustment system that may be used to implement the first software adjustment system and/or the second software adjustment system of FIG. 2.

FIG. 4 is a block diagram illustrating an example implementation of the variant generator of FIG. 3.

FIG. 5 is a flowchart representative of machine readable instructions 500 which may be executed to implement the variant generator of FIGS. 3 and 4 in a training phase.

FIG. 6 is a flowchart representative of machine readable instructions which may be executed to implement the variant generator of FIGS. 3 and 4 during an inference phase.

FIG. 7 is a flowchart representative of machine readable instructions which may be executed to implement the executable of FIG. 3.

FIG. 8 is a block diagram of an example processing platform structured to execute the instructions of FIGS. 5 and 6 to implement the variant generator of FIGS. 3 and 4.

FIG. 9 is a block diagram of an example processing platform structured to execute the instructions of FIG. 7 to implement the executable of FIG. 3.

The figures are not to scale. In general, the same reference numbers will be used throughout the drawing(s) and accompanying written description to refer to the same or like parts. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other.

Descriptors “first,” “second,” “third,” etc. are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

As previously mentioned, many computer hardware manufacturers and/or other providers develop programs and/or other methods to compile algorithms and/or other code to be run on a specific processing platform. For example, some computer hardware manufacturers develop programs and/or other methods to compile algorithms and/or other code to be run on a GPU, a VPU, a CPU, or an FPGA. Such programs and/or other methods function using domain specific languages (DSLs). DSLs (e.g., Halide, OpenCL, etc.) utilize the principle of separation of concerns to separate how an algorithm (e.g., a program, a block of code, etc.) is written from how the algorithm is executed. For example, many DSLs allow a developer to represent an algorithm in a high level functional language without worrying about the performant mapping to the underlying hardware and also allows the developer to implement and explore high-level strategies to map the algorithm to the hardware (e.g., by a process called schedule specification) to obtain a performant implementation.

For example, an algorithm may be defined to blur an image (e.g., how the algorithm is written) and a developer may desire that the algorithm run effectively on a CPU, a VPU, a GPU, and an FPGA. To effectively run the algorithm on the various types of processing elements (e.g., CPU, VPU, GPU, FPGA, a heterogeneous system, etc.), a schedule is to be generated. To generate the schedule, the algorithm is transformed in different ways depending on the particular processing element. Many methods of automating compilation time scheduling of an algorithm have been developed. For example, compilation auto-scheduling, may include auto-tuning, heuristic searching, and hybrid scheduling.

Auto-tuning includes compiling an algorithm in a random way, executing the algorithm, measuring the performance of the processing element, and repeating the process until a threshold of performance has been met (e.g., power consumption, speed of execution, etc.). However, in order to achieve a desired threshold of performance, an extensive compilation time may be required, and the compilation time is compounded as the complexity of the algorithm increases.

Heuristic searching includes (1) applying rules that define types of algorithm transformations that will improve the performance to meet a performance threshold, and (2) applying rules that define types of algorithm transformations that will not improve the performance to meet the performance threshold. Then, based on the rules, a search space can be defined and searched based on a cost model. The cost model, however, is generally specific to a particular processing element. Complex modern hardware (e.g., one or more processing elements) is difficult to model empirically and typically only hardware accelerators are modeled. Similarly, the cost model is difficult to define for an arbitrary algorithm. For example, cost models work for predetermined conditions, but for complex and stochastic conditions cost models generally fail.

Hybrid scheduling includes utilizing artificial intelligence (AI) to identify a cost model for a generic processing element. The cost model can correspond to representing, predicting, and/or otherwise determining computation costs of one or more processing elements to execute a portion of code to facilitate processing of one or more workloads. For example, artificial intelligence including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. Some types of machine learning models include, for example, a support vector machine (SVM), a neural network (NN), a recurrent neural network (RNN), a convolutional neural network (CNN), a long short term memory (LSTM), a gate recurrent unit (GRU), etc.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

Training is performed using training data. Once training is complete, the model is deployed for use as an executable construct that processes an input and provides an output based on the network of nodes and connections defined in the model.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, loop transformation, an instruction sequence to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

Regardless of the ML/AI model that is used, once the ML/AI model is trained, the ML/AI model generates a cost model for a generic processing element. The cost model is then utilized by an auto-tuner to generate a schedule for an algorithm. Once a schedule is generated, the schedule is combined with the algorithm specification to generate an executable file (either for Ahead of Time or Just in Time paradigms).

The executable file includes a number of different executable sections, where each executable section is executable by a specific processing element, and the executable file is referred to as a fat binary. For example, if a developer is developing code to be used on a heterogeneous processing platform including a GPU, a CPU, a VPU, and an FPGA, an associated fat binary will include executable sections for the GPU, the CPU, the VPU, and the FPGA, respectively. In such examples, a runtime scheduler can utilize the fat binary to execute the algorithm on at least one of the GPU, the CPU, the VPU, and the FPGA depending on the physical characteristics of the heterogeneous system as well as environmental factors. A function that defines success for the execution (e.g., a function designating successful execution of the algorithm on the heterogeneous system). For example, such a success function may correspond to executing the function to meet and/or otherwise satisfy a threshold of power consumption. In other examples, a success function may correspond to executing the function in a threshold amount of time. However, a runtime scheduler may utilize any suitable success function when determining how to execute the algorithm, via the fat binary, on a heterogeneous system.

While auto-tuning, heuristic searching, and AI based hybrid methods may be acceptable methods of scheduling during compilation time, such methods of scheduling do not account for the load and real-time performance of the individual processing elements of heterogeneous systems. For example, when developing cost models, a developer or AI system makes assumptions about how a particular processing element (e.g., a GPU, a CPU, an FPGA, or a VPU) is structured. Moreover, a developer or AI system may make assumptions regarding the particular computational elements, memory subsystems, interconnections fabrics, and/or other components of a particular processing element. However, these components of the particular processing element are volatile, sensitive to load and environmental conditions, include nuanced hardware design details, have problematic drivers/compilers, and/or include performance behavior that is counterintuitive to expected performance.

For example, when a heterogeneous system offloads one or more computation tasks (e.g., a workload, a computation workload, etc.) to a GPU, there are particular ramifications for not offloading enough computation to the GPU. More specifically, if an insufficient quantity of computation tasks are offloaded to a GPU, one or more hardware threads of the GPU can stall and cause one or more execution units of the GPU to shut down and, thus, limit processing power of the GPU. An example effect of such a ramification can be that a workload of size X offloaded to the GPU may have the same or substantially similar processing time as a workload of size 0.5X offloaded to the GPU.

Furthermore, even the movement of data from one processing element to another processing element can cause complications. For example, a runtime scheduler may utilize a GPU's texture sampler to process images in a workload. To offload the workload to the GPU, the images are converted from a linear format supported by the CPU to a tiled format supported by the GPU. Such a conversion incurs computational cost on the CPU and while it may be faster, to process the image on the GPU, the overall operation of converting the format of the image on the CPU and subsequent processing on the GPU may be longer than simply processing the image on the CPU.

Additionally, many compilers utilize an auto-vectoring which relies on a human developer's knowledge of transformations and other scheduling techniques to trigger the auto-vectorizing functionality. Thus, a developer who is unaware of these techniques will have a less than satisfactory executable file.

Examples disclosed herein include methods and apparatus to improve runtime performance of software executing on a heterogeneous system. As opposed to some methods for compilation scheduling, the examples disclosed herein do not rely solely on theoretical understanding of processing elements, developer knowledge of algorithm transformations and other scheduling techniques, and the other pitfalls of some methods for compilation scheduling.

Examples disclosed herein collect actual performance characteristics as well as the difference between the desired performance (e.g., a success function) and the actual performance attained. Examples disclosed herein provide an apparatus including a feedback interface to collect a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element; a performance analyzer to determine a performance delta based on the performance characteristic and the function; and a machine learning modeler to, prior to a second runtime, adjust a cost model of the first processing element based on the performance delta, the adjusted cost model to cause a reduction in the performance delta to improve runtime performance of the heterogeneous system.

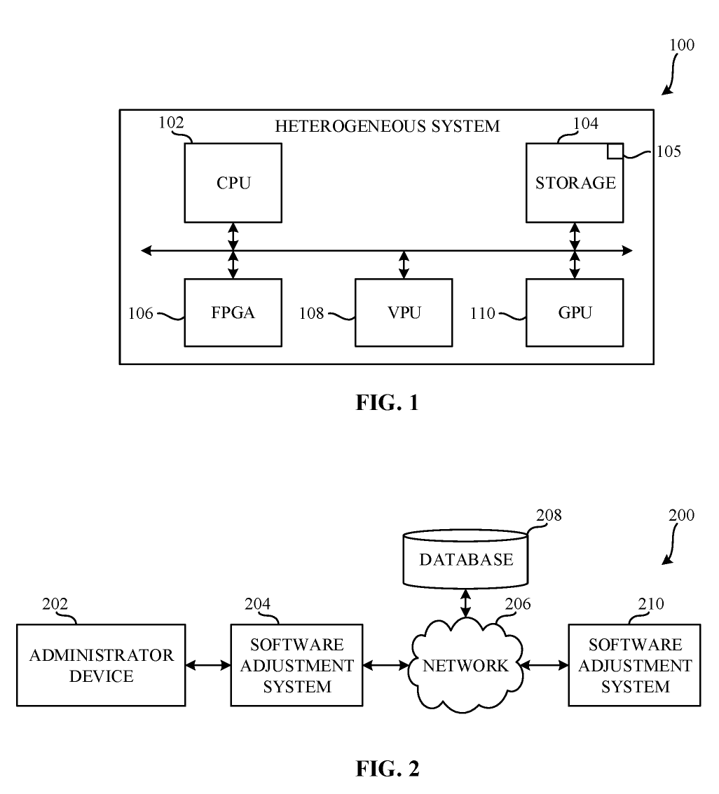

FIG. 1 is a block diagram illustrating an example heterogeneous system 100. In the example of FIG. 1, the heterogeneous system 100 includes an example CPU 102, an example storage 104, an example FPGA 106, an example VPU 108, and an example GPU 110. The example storage 104 includes an example executable 105. Alternatively, the storage 104 may include more than one executable. In FIG. 1, the heterogeneous system 100 is a system on a chip (SoC). Alternatively, the heterogeneous system 100 may be any other type of computing or hardware system.

In examples disclosed herein, each of the CPU 102, the storage 104, the FPGA 106, the VPU 108, and the GPU 110 is in communication with the other elements of the heterogeneous system 100. For example, the CPU 102, the storage 104, the FPGA 106, the VPU 108, and the GPU 110 are in communication via a communication bus. In some examples disclosed herein, the CPU 102, the storage 104, the FPGA 106, the VPU 108, and the GPU 110 may be in communication via any suitable wired and/or wireless communication method. Additionally, in some examples disclosed herein, each of the CPU 102, the storage 104, the FPGA 106, the VPU 108, and the GPU 110 may be in communication with any component exterior to the heterogeneous system 100 via any suitable wired and/or wireless communication method.

In the example of FIG. 1, the CPU 102 is a processing element that executes instructions (e.g., machine-readable instructions that are included in and/or otherwise correspond to the executable 105) to execute, perform, and/or facilitate a completion of operations associated with a computer or computing device. In the example of FIG. 1, the CPU 102 is a primary processing element for the heterogeneous system 100 and includes at least one core. Alternatively, the CPU 102 may be a co-primary processing element (e.g., in an example where more than one CPU is utilized) while, in other examples, the CPU 102 may be a secondary processing element.

In the example illustrated in FIG. 1, the storage 104 is a memory including the executable 105. Additionally or alternatively, the executable 105 may be stored in the CPU 102, the FPGA 106, the VPU 108, and/or the GPU 110. In FIG. 1, the storage 104 is a shared storage between at least one of the CPU 102, the FPGA 106, the VPU 108, and the GPU 110. In the example of FIG. 1, the storage 104 is a physical storage local to the heterogeneous system 100; however, in other examples, the storage 104 may be external to and/or otherwise be remote with respect to the heterogeneous system 100. In further examples, the storage 104 may be a virtual storage. In the example of FIG. 1, the storage 104 is a persistent storage (e.g., read only memory (ROM), programmable ROM (PROM), erasable PROM (EPROM), electrically erasable PROM (EEPROM), etc.). In other examples, the storage 104 may be a persistent basic input/output system (BIOS) or a flash storage. In further examples, the storage 104 may be a volatile memory.

In the illustrated example of FIG. 1, one or more of the FPGA 106, the VPU 108, and the GPU 110 are processing elements that may be utilized by a program executing on the heterogeneous system 100 for computing tasks, such as hardware acceleration. For example, the FPGA 106 is a versatile programmable processing element that can be used for a computable operation or process. In other examples, the VPU 108 is a processing element that includes processing resources that are designed and/or otherwise configured or structured to improve the processing speed and overall performance of processing machine vision tasks for AI. In yet other examples, the GPU 110 is a processing element that is designed to improve the processing speed and overall performance of processing computer graphics and/or image processing. While the FPGA 106, the VPU 108, and GPU 110 include functionality to support specific processing tasks, one or more of the FPGA 106, the VPU 108, and/or the GPU 110 can correspond to processing elements that support general processing tasks that may be offloaded from the CPU 102 on an as needed basis.

While the heterogeneous system 100 of FIG. 1 includes the CPU 102, the storage 104, the FPGA 106, the VPU 108, and the GPU 110, in some examples, the heterogeneous system 100 may include any number of processing elements including application-specific instruction set processors (ASIPs), physic processing units (PPUs), digital signal processors (DSPs), image processors, coprocessors, floating-point units, network processors, multi-core processors, and front-end processors.

FIG. 2 is a block diagram illustrating an example network 200 including an example administrator device 202, an example first software adjustment system 204, an example network 206, an example database 208, and an example second software adjustment system 210.

In the example of FIG. 2, the administrator device 202 is a desktop computer. In other examples, the administrator device 202 may be any suitable computing system such as a mobile phone, a tablet computer, a workstation, a laptop computer, or a server. In the example of FIG. 2, an administrator may train the first software adjustment system 204 via the administrator device 202. For example, an administrator may generate training data via the administrator device 202. In examples disclosed herein, the training data originates from randomly generated algorithms that are subsequently utilized by the first software adjustment system 204. For example, an administrator may use the administrator device 202 to generate and transmit a large quantity (e.g., thousands to hundreds of thousands) of algorithms to the first software adjustment system 204 to train the first software adjustment system 204. The administrator device 202 is in communication with the first software adjustment system 204 via a wired connection. However, in other examples, the administrator device 202 may be in communication with the first software adjustment system 204 via any suitable wired and/or wireless connection.

In the example illustrated in FIG. 2, each of the first software adjustment system 204 and the second software adjustment system 210 generates and improves the execution of applications on heterogeneous systems (e.g., the heterogeneous system 100). Each of the first software adjustment system 204 and the second software adjustment system 210 utilizes ML/AI techniques to generate applications based on received algorithms and performance of a processing element.

In the example of FIG. 2, the first software adjustment system 204 is in communication with the administrator device 202 via a wired connection, however, in other examples, the first software adjustment system 204 may be in communication with the administrator device 202 via any suitable wired and/or wireless connection. Additionally, the first software adjustment system 204 is in communication with the database 208 and the second software adjustment system 210 via the network 206. The first software adjustment system 204 may be in communication with the network 206 via any suitable wired and/or wireless connection.

In the example illustrated in FIG. 2, the first software adjustment system 204 trains an ML/AI model to generate a trained ML/AI model that can be utilized to develop code and/or other algorithms for execution on a heterogeneous system. The first software adjustment system 204 transmits the trained ML/AI model. For example, the first software adjustment system 204 transmits the trained ML/AI model to the database 208 via the network 206. Additionally or alternatively, the first software adjustment system 204 transmits the trained ML/AI model to the second software adjustment system 210.

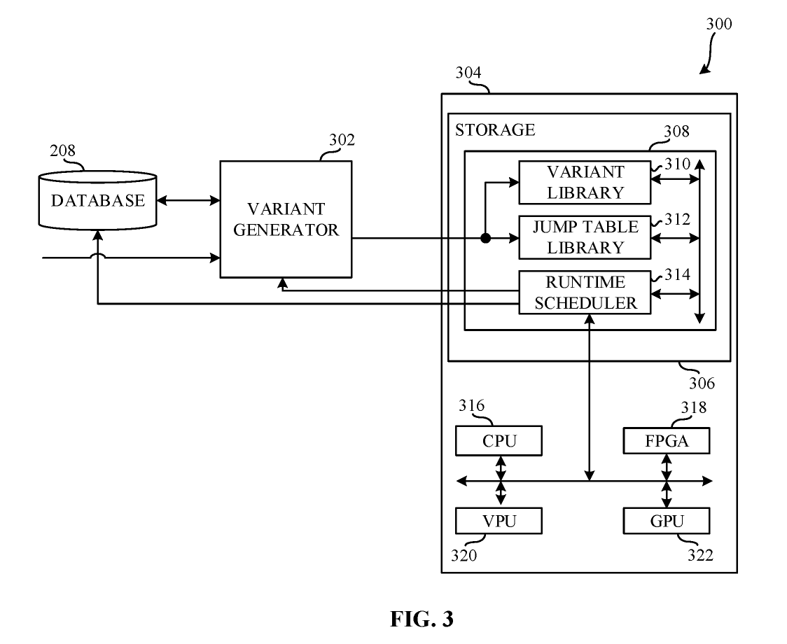

In the example of FIG. 2, the second software adjustment system 210 utilizes the trained ML/AI model to execute code and/or other algorithms on a heterogeneous system. The second software adjustment system 210 may obtain the trained ML/AI model from the first software adjustment system 204, the database 208, or the second software adjustment system 210 may generate the trained ML/AI model. The second software adjustment system 210 additionally collects data associated with the heterogeneous system and a system-wide success function of the heterogeneous system. After collecting the data, the second software adjustment system 210 transmits the data to the first software adjustment system 204 and/or the database 208. The second software adjustment system 210 may format the data in a variety of ways that will be discussed further in connection with FIG. 3.

In the illustrated example of FIG. 2, the network 206 is a network connecting one or more of the first software adjustment system 204, the database 208, and the second software adjustment system 210. For example, the network 206 may be a local area network (LAN), a wide area network (WAN), wireless local area network (WLAN), the Internet, or any other suitable network. The network 200 includes the database 208 to record and/or otherwise store data (e.g., heterogeneous system performance data, a system-wide success function, the trained ML/AI model 214, etc.). The database 208 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The database 208 may additionally or alternatively be implemented by one or more double data rate (DDR) memories, such as DDR, DDR2, DDR3, DDR4, mobile DDR (mDDR), etc. The database 208 may additionally or alternatively be implemented by one or more mass storage devices such as hard disk drive(s), compact disk drive(s), digital versatile disk drive(s), solid-state disk drive(s), etc. While in the illustrated example the database 208 is illustrated as a single database, the database 208 may be implemented by any number and/or type(s) of databases. Furthermore, the data stored in the database 208 may be in any data format such as, for example, binary data, comma delimited data, tab delimited data, structured query language (SQL) structures, etc. In FIG. 2, the database 208 is an organized collection of data, stored on a computational system that is electronically accessible. For example, the database 208 may be stored on a server, a desktop computer, an HDD, an SSD, or any other suitable computing system.

FIG. 3 is a block diagram illustrating an example software adjustment system 300 that may be used to implement the first software adjustment system 204 and/or the second software adjustment system 210 of FIG. 2. The example software adjustment system 300 includes two operational phases, training phase and inference phase.

In the example of FIG. 3, the software adjustment system 300 includes an example variant generator 302, an example heterogeneous system 304, and an example storage 306. The example storage 306 includes the example executable 308. The example executable 308 includes an example variant library 310, an example jump table library 312, and an example runtime scheduler 314. The example heterogeneous system 304 includes an example CPU 316, an example FPGA 318, an example VPU 320, and an example GPU 322. In the example of FIG. 3, the example heterogeneous system 304 is similar to the heterogeneous system 100 of FIG. 1 where the storage 306 is internal to the heterogeneous system 304. However, in other examples, the storage 306 may be external to the heterogeneous system 304. In the example illustrated in FIG. 3, the variant generator 302 may be located at a remote facility (e.g., remote with respect to the heterogeneous system 304) and the variant generator 302 may be a cluster of computers (e.g., a server room).

In the illustrated example of FIG. 3, the variant generator 302 is coupled to one or more external devices, the database 208 of FIG. 2, the storage 306, the variant library 310, the jump table library 312, and the runtime scheduler 314. The variant generator 302 may receive algorithms and/or machine learning models from an external device. For example, in an example training phase, the variant generator 302 may receive and/or otherwise obtain random algorithms from an external device. While in an example inference phase, the variant generator 302 may receive and/or otherwise obtain user generated algorithms and/or trained ML/AI models from one or more external devices.

In the example of FIG. 3, the variant generator 302 is a device that compiles algorithms received from an external device into an executable application including a number of variants of the algorithms. Additionally or alternatively, the variant generator 302 generates trained ML/AI models associated with generating applications to be run on a heterogeneous system. For example, if the algorithms received from an external device are written in C/C++, the variant generator 302 compiles the algorithms into executable applications for storage in the storage 306. In examples disclosed herein, the executable applications compiled by variant generator 302 are fat binaries. However, in other examples, the executable application compiled by the variant generator 302 may be any suitable executable file.

In the example of FIG. 3, the variant generator 302 utilizes ML/AI techniques. In examples disclosed herein, the variant generator 302 utilizes a deep neural network (DNN) model. In general, machine learning models/architectures that are suitable to use in the example approaches disclosed herein will be supervised. However, other examples may include machine learning models/architectures that utilize unsupervised learning. In examples disclosed herein, ML/AI models are trained using gradient descent. In examples disclosed herein, the hyperparameters utilized to train the ML/AI model control the exponential decay rates of the moving averages of the gradient descent. Such hyperparameters are selected by, for example, iterating through a grid of hyperparameters until the hyperparameters meet an acceptable value of performance. However, any other training algorithm may additionally or alternatively be used.

In the example illustrated in FIG. 3, during the training phase, the variant generator 302 functions to generate a trained ML/AP model that is capable of generating an executable application that include multiple variants of an algorithm that can be run on a variety of processing elements. When in the training phase, the variant generator 302 selects a processing element (e.g., the CPU 316, the FPGA, 318, the VPU 320, or the GPU 322) for which the variant generator 302 is to develop one or more variants and a corresponding executable application. Upon selection of a processing element, for example the FPGA 318, the variant generator 302, when in the training phase, selects an aspect of the processing element to optimize. For example, the variant generator 302 selects speed of execution of the algorithm on the FPGA 318 to optimize.

In the example of FIG. 3, after selecting an aspect of a processing element to optimize, the variant generator 302 utilizes a machine learning model (e.g., a DNN) to generate a cost model of the processing element. The variant generator 302 then utilizes auto-tuning techniques to develop a schedule to map the algorithm to the selected processing element so that it will improve the selected aspect. For example, the variant generator 302 utilizes auto-tuning techniques to develop a schedule to map the algorithm to the FPGA 318 so that the mapping of the algorithm to the FPGA 318 will improve the speed of execution of the algorithm on the FPGA 318.

In the illustrated example of FIG. 3, after developing a particular schedule for the particular processing element, the variant generator 302 compiles the algorithm into a variant according to the schedule. This compilation differs from the compilation of the executable application because the variant generator 302 is compiling the algorithm into a method, class, or object that can be called by the executable application (e.g., the executable 308). After compiling the variant, the variant generator 302, when in the training phase, transmits the variant to the executable 308 in the storage 306. For example, the executable 308 is a fat binary stored in the storage 306 and the variant generator 302 stores the variant in the variant library 310. Additionally, the variant generator 302, when in the training phase, transmits a variant symbol to the executable 308 in the storage 306. The variant symbol is a data element that corresponds to a location of the variant in the variant library 310.

In the example of FIG. 3, the variant is subsequently executed on the heterogeneous system 304. After the variant is executed on the heterogeneous system 304, the variant generator 302 collects performance characteristics associated with the selected processing element (e.g., the FPGA 318). The performance characteristics when in training mode, are characteristics of the selected processing element (e.g., the FPGA 318) include, for example, power consumption of the selected processing element, time to run on the selected processing element, and other performance characteristics associated with the selected processing element.

In the example of FIG. 3, the variant generator 302 analyzes the collected data and determines whether the variant used met a performance threshold. In examples disclosed herein, training is performed until the performance threshold is met. For example, the performance threshold corresponds to an acceptable amount of L2 (least squares regression) error is achieved for the selected aspect. Once the performance threshold has been met, the variant generator 302 determines whether there are subsequent aspects to be optimized. If so, the variant generator 302 generates an additional variant for the selected processing element (e.g., power consumption for the FPGA 318). If not, the variant generator 302 determines whether there are subsequent processing elements to generate one or more variants for (e.g., variants generated for CPU 316, the VPU 320, or the GPU 322 as opposed to variants for the FPGA 318).

In the example of FIG. 3, after the variant generator 302 generates variants for all the processing elements of the heterogeneous system 304, the variant generator 302 determines whether there are additional algorithms for which to generate variants. If so, the variant generator 302 generates variants of the additional algorithm for each processing element of the heterogeneous system 304 for any selected and/or arbitrary aspects of each of the processing elements. If there are no additional algorithms, the variant generator 302 outputs the trained ML/AI model. For example, the variant generator 302 may output one or more files including weights associated with the cost model of each processing element of the heterogeneous system 304. The model may be stored at the storage 306, the database 208, and/or an additional variant generator. The model may then be executed by the variant generator 302 on a subsequent execution or an additional variant generator.

In the example of FIG. 3, after outputting the trained ML/AI model, the variant generator 302 monitors for any additional input data. For example, the input data may be data associated with the execution of an application generated by the trained ML/AI model on a target platform (e.g., the heterogeneous system 304). The specific data obtained by the variant generator 302 is indicative of the performance of the target platform when executing a desired workload and reflects the actual system under a load and not a test system. Upon receiving and/or otherwise obtaining input data, the variant generator 302 identifies the success function of the heterogeneous system 304. Based on the success function, the variant generator 302 determines the difference between the desired performance (e.g., a performance threshold) defined by the success function and the actual performance achieved during execution of the algorithm during the inference phase.

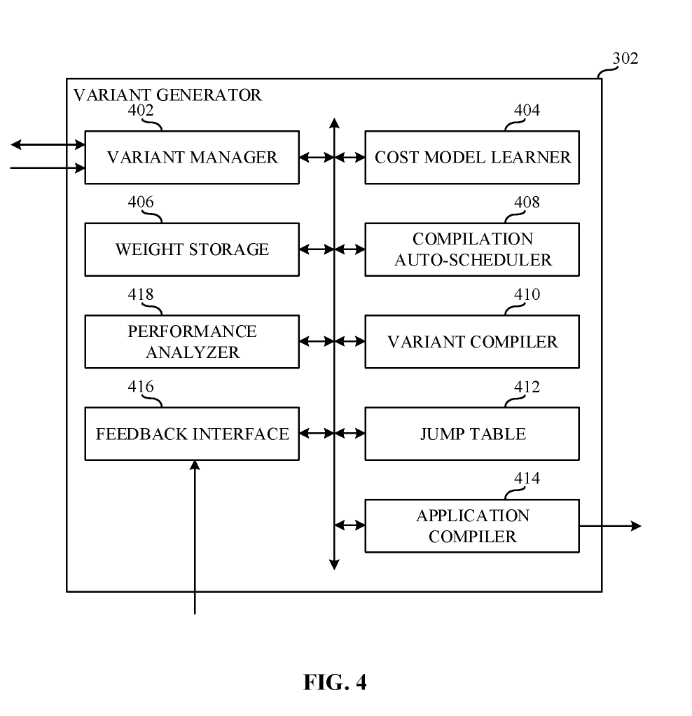

In the example of FIG. 3, after the variant generator 302 determines the success function and related aspect of the overall system e.g., the heterogeneous system 304) to target and the performance delta associated with the success function, the variant generator 302 updates and/or otherwise adjusts the cost models associated with the respective processing elements of the heterogeneous system 304 to account for the real-time characteristics and load of the heterogeneous system 304. The updated and/or otherwise adjusted cost models effectively reduce (e.g., cause a reduction) the performance delta between the performance characteristics and the overall success function of the heterogeneous system 304. The updating and other adjustment of the cost models associated with the respective processing elements of a heterogeneous system will be discussed further in FIG. 4.

In the example illustrated in FIG. 3, the variant library 310 is a data structure associated with the executable 308 that stores the different variants of an algorithm that the executable 308 performs. For example, the variant library 310 is a data-section of a fat binary that includes the different variants associated with a particular algorithm, such as variants associated with the respective processing elements of a heterogeneous system. For each processing element, the variant library 310 may additionally include variants that target different aspects of performance of the respective processing elements. Moreover, the variant library 310 is linked to the example jump table library 312 and/or the runtime scheduler 314. The variant library 310 is a static library during execution of the executable 308 but may be updated with new or altered variants between executions of the executable 308.

In the example of FIG. 3, the jump table library 312 is a data structure associated with the executable 308 that stores a jump table including variant symbols that point to the location of respective variants in the variant library 312. For example, the jump table library 312 is a data-section of the executable 308 that includes a jump table associating various variant symbols (e.g., pointers) which respective variants located in the variant library 310. The jump table library 312 does not change during execution of the executable 308, however, the jump table library 312 may be accessed to call a respective variant to be loaded onto one or more of the processing elements of a heterogeneous system.

In the example illustrated in FIG. 3, the runtime scheduler 314 is a virtual machine that determines how to execute a workload (e.g., an algorithm and/or algorithms) during runtime of a heterogeneous system. For example, the runtime scheduler 314 determines whether a workload should be offloaded from one processing element to another processing element in order to achieve a performance goal associated with the overall heterogeneous system. In the example of FIG. 3, during execution of the executable 308, the runtime scheduler 314 monitors the heterogeneous system 304 and profiles the performance of the heterogeneous system 304 based on performance characteristics and offloads a workload from one processing element to another. For example, during runtime of the heterogeneous system 304, the executable 308 is executed by the CPU 316. In some examples, the CPU 316 executes the executable 308 from the storage 306 while in other examples the CPU 316 executes the executable 308 locally on the CPU 316.

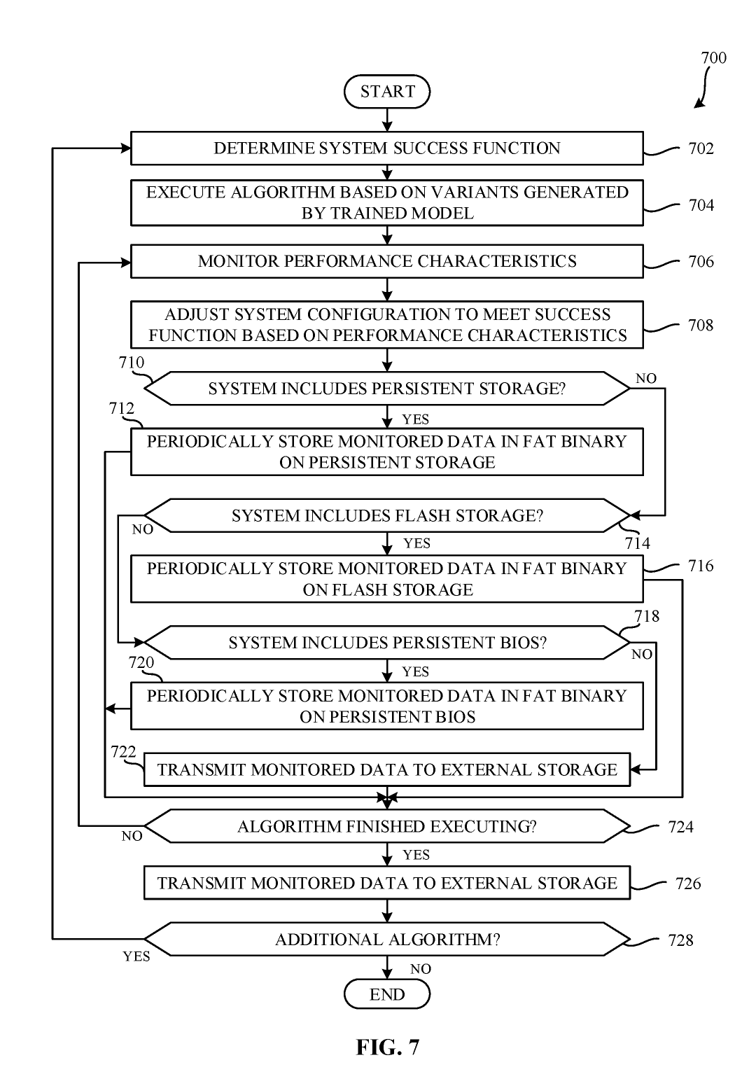

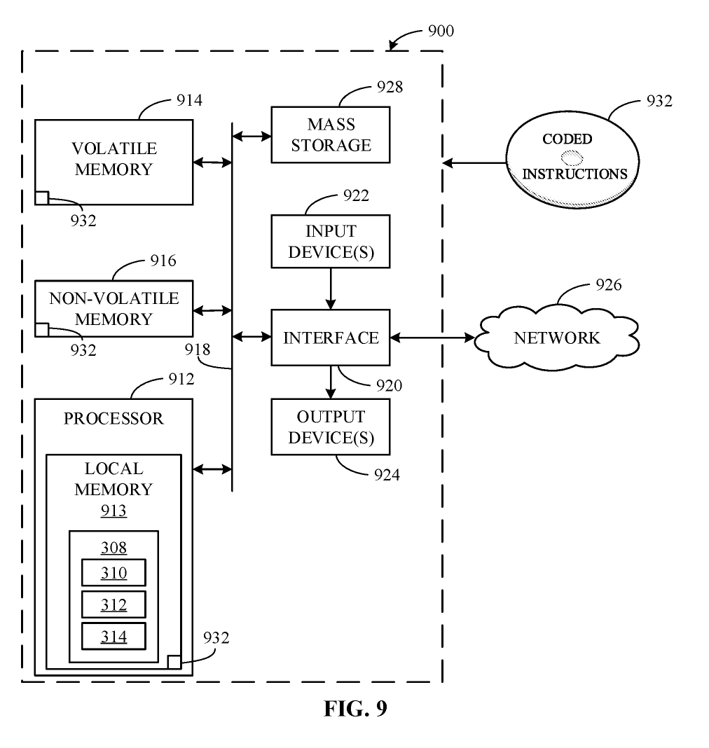

In some examples, the example runtime scheduler 314 implements example means for runtime scheduling of a workload. The runtime scheduling means is implemented by executable instruction such as that implemented by at least blocks 702-728 of FIG. 7, which may be executed on at least one processor such as the example processor 912 shown in the example of FIG. 9. In other examples, the runtime scheduling means is implemented by hardware logic, hardware implemented state machines, logic circuitry, and/or any other combination of hardware, software, and/or firmware.

In the example of FIG. 3, upon execution of the executable 308 by the CPU 316, the runtime scheduler 314 determines a success function. For example, during a training phase, the success function is associated with particular processing element (e.g., the GPU 322) for which the ML/AI model is being trained. While the runtime scheduler 314 determines a success function for a particular processing element when operating in the training phase, when operating in the inference phase, the runtime scheduler 314 determines a system-wide success function. For example, the system-wide success function may be associated with the consumption of threshold amount power while another system-wide success function may be associated with executing the algorithm associated with an executable application as quickly as possible. The system-wide success function may be based on the overall state of the heterogeneous system 304. For example, if the heterogeneous system 304 is located on a laptop computer that is in a low-power mode, the system-wide success function may be associated with conserving power whereas under normal operating conditions of the laptop computer, the system-wide success function may be associated with speed of execution of the algorithm.

In the example of FIG. 3, the success function may additionally be specific to the hardware of the heterogeneous system 304. For example, the success function may be associated with utilizing the GPU 322 beyond a threshold amount, preventing contention between CPU 316 threads, or utilizing the high-speed memory of the VPU 320 beyond a threshold amount. A success function may be a composite of simpler success functions, such as overall performance of the heterogeneous system 304 per Watt.

In the illustrated example of FIG. 3, after identifying a success function, the runtime scheduler 314 executes the executable 308 based on the variants generated by a ML/AI model. For example, during the training phase, the ML/AI model that generated the variants is not trained and the runtime scheduler 314 is concerned with the specific performance of the processing element with which the ML/AI model is being trained. However, during the inference phase, the ML/AI model that generated the variants is trained and the runtime scheduler 314 is concerned with the specific performance of the heterogeneous system 304 as a whole. For example, during an inference phase, the runtime scheduler 314 can collect specific performance characteristics associated with the heterogeneous system 304 and stores and/or transmits these performance characteristics for future use.

In the example of FIG. 3, during an inference phase, the runtime scheduler 314 collects performance characteristics including metadata and metric information associated with each variant included in the executable 308. For example, such metadata and metric information includes an identifier for the workload (e.g., a name of the algorithm), compatibility constraints associated with drivers and other hardware of the heterogeneous system 304, version of the cost model utilized to generate a variant, algorithm execution size, and other data that ensures compatibility between execution of a workload (e.g., a variant) on each processing element and informs the runtime scheduler 314 of offload decisions. The performance characteristics collected during an inference phase by the runtime scheduler 314 may further include average execution time of a variant on each processing element, average occupancy of each processing element during runtime, stall rates, power consumption of the individual processing elements, computational cycle counts utilized by a processing element, memory latency when offloading a workload, hazards of offloading a workload from one processing element to another, system-wide battery life, amount of memory utilized, metrics associated with a communication bus between the various processing elements, and metrics associated with the memory of the heterogeneous system 304 (e.g., the storage 306).

In the example of FIG. 3, the runtime scheduler 314, during an inference phase, additionally collects data associated with the state transition data relating to the load and environmental conditions of the heterogeneous system 304 (e.g., why the runtime scheduler 314 accessed the jump table library 312 and where/why the runtime scheduler 314 offloaded the workload). The state transition data includes, for example, runtime scheduling rules associated with thermal and power characteristics of the heterogeneous system 304 as well as runtime scheduling rules associated with any other condition that may perturb (e.g., influence) the performance of the heterogeneous system 304.

In the illustrated example of FIG. 3, after monitoring the performance characteristics, the runtime scheduler 314 adjusts the configuration of the heterogeneous system 304 based on the success function of the heterogeneous system 304. Periodically, throughout the operation of the runtime scheduler 314, during an inference phase, the runtime scheduler 314 may store and/or transmit the performance characteristics for further use by the variant generator 302. In order to do so, the runtime scheduler 314 identifies whether the heterogeneous system 304 includes persistent storage (e.g., ROM, PROM, EPROM, etc.), a persistent BIOS, or a flash storage.

In the example of FIG. 3, if the heterogeneous system 304 includes a persistent storage, the runtime scheduler 314 will write to a data-section in the executable 308 (e.g., the fat binary) to store the performance characteristics. The performance characteristics are stored in the executable 308 to avoid the possibility of history loss across different executions of the executable 308. In order to store the performance characteristics, the runtime scheduler 314, executing on the CPU 316 as an image of the executable 308 stores the performance characteristics in executable 308 stored in the storage 306. If the heterogeneous system 304 does not include a persistent storage, but rather a flash storage or a persistent BIOS, a similar method of storing the performance characteristic in the executable 308 may be implemented.

In the example of FIG. 3, if there is no form of a persistent storage, a persistent BIOS, or a flash storage (for example, if the storage 306 is a volatile memory), the runtime scheduler 314 may alternatively transmit the collected performance characteristics to an external device utilizing a communication port. For example, the runtime scheduler 314 may utilize a USB, an ethernet, a serial, or any other suitable communication interface to transmit the collected performance characteristics to an external device. The external device may be for example, the database 208 and/or the variant generator 302.

In the illustrated example of FIG. 3, regardless of the method utilized by the runtime scheduler 314 to store the performance characteristics during an inference phase, after the executable 308 is executed on the heterogeneous system 304, the runtime scheduler 314 transmits the performance characteristics as well as a performance delta associated with the system wide success function. The performance delta may indicate, for example, the difference in the desired performance and the performance achieved.

In the example of FIG. 3, on subsequent executions of the executable 308, the runtime scheduler 314 may access the stored performance characteristics and adjusted and/or otherwise improved ML/AI models to improve the handling of offloading variants. For example, the stored performance characteristics and adjusted ML/AI models that the runtime scheduler 314 may access include bus traffic under load, preemptive actions taken by the operating system on the heterogeneous system, decoding latencies associated with video and audio processing, and any other data that can help inform offloading decisions. For example, if the runtime scheduler 314 encounters an algorithm that includes decoding video and offloading, the video decoding may start out on the GPU 322. Although the runtime scheduler 314 may have a variant for another processing element (e.g., the VPU 320) at its disposal that will, in isolation, process the video decoding more quickly than the variant executing on the GPU 322, it may be quicker to execute the video decoding on the GPU 322 due to memory movement latencies associated with moving the workload from the GPU 322 to another processing element.

FIG. 4 is a block diagram illustrating an example implementation of the variant generator 302 of FIG. 3. The variant generator 302 includes an example variant manager 402, an example cost model learner 404, an example weight storage 406, an example compilation auto-scheduler 408, an example variant compiler 410, an example jump table 412, an example application compiler 414, an example feedback interface 416, and an example performance analyzer 418.

In examples disclosed herein, each of the variant manager 402, the cost model learner 404, the weight storage 406, the compilation auto-scheduler 408, the variant compiler 410, the jump table 412, the application compiler 414, the feedback interface 416, and the performance analyzer 418 is in communication with the other elements of the variant generator 302. For example, the variant manager 402, the cost model learner 404, the weight storage 406, the compilation auto-scheduler 408, the variant compiler 410, the jump table 412, the application compiler 414, the feedback interface 416, and the performance analyzer 418 are in communication via a communication bus.

In some examples disclosed herein, the variant manager 402, the cost model learner 404, the weight storage 406, the compilation auto-scheduler 408, the variant compiler 410, the jump table 412, the application compiler 414, the feedback interface 416, and the performance analyzer 418 may be in communication via any suitable wired and/or wireless communication method.

Additionally, in some examples disclosed herein, each of the variant manager 402, the cost model learner 404, the weight storage 406, the compilation auto-scheduler 408, the variant compiler 410, the jump table 412, the application compiler 414, the feedback interface 416, and the performance analyzer 418 may be in communication with any component exterior to the variant generator 302 via any suitable wired and/or wireless communication method.

In the example of FIG. 4, the variant manager 402 analyzes communications received from devices external to the variant generator 302 (e.g., the database 208 and/or the administrator device 202) and manage. For example, the variant manager 402 receives and/or otherwise obtains an algorithm from an external device. For example, during a training phase, the variant manager 402 obtains an arbitrary algorithm in a series of arbitrary algorithms that are utilized to train the variant manager 402. Additionally or alternatively, during an inference phase, the variant manager 402 obtains an algorithm associated with a workload to be executed on a heterogeneous system.

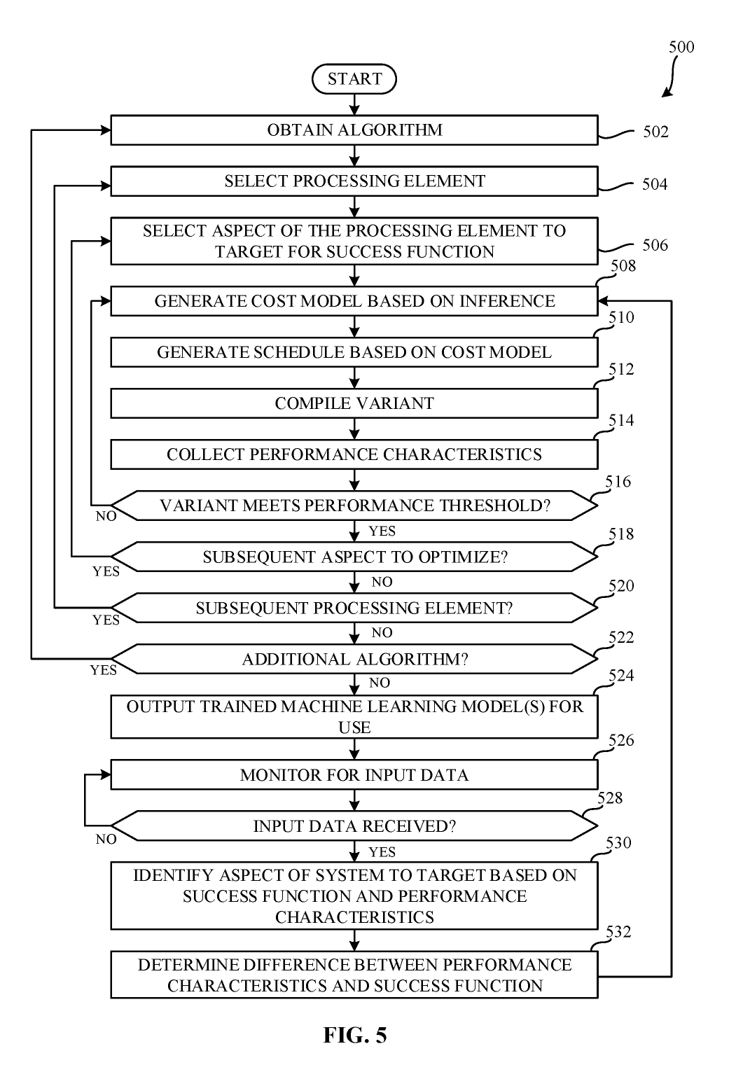

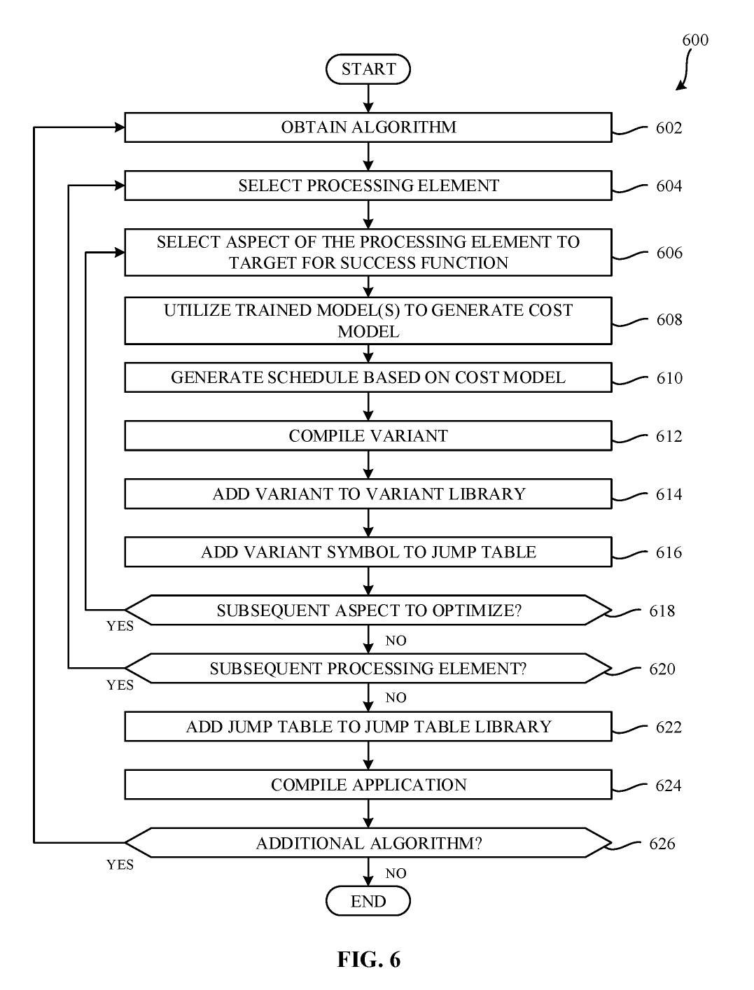

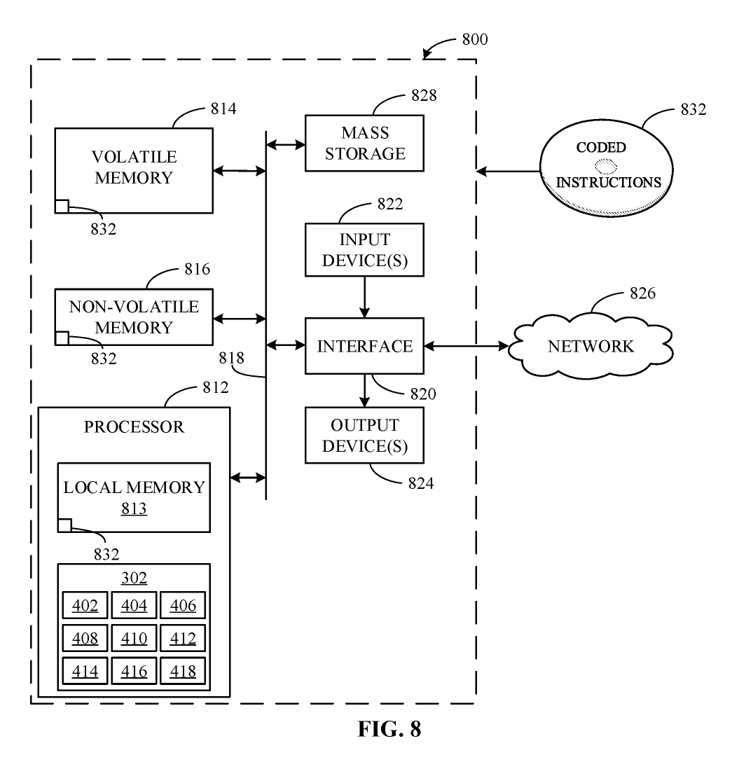

In some examples, the variant manager 402 implements example means for managing algorithms for which the variant generator 302 is to generate variants. The managing means is implemented by executable instruction such as that implemented by at least blocks 502, 504, 506, 518, 520, 522, and 524 of FIG. 5 and blocks 602, 604, 606, 618, 620, and 626 of FIG. 6, which may be executed on at least one processor such as the example processor 812 shown in the example of FIG. 8. In other examples, the managing means is implemented by hardware logic, hardware implemented state machines, logic circuitry, and/or any other combination of hardware, software, and/or firmware.

In the example of FIG. 4, after retrieving an algorithm from an external device, the variant manager 402 selects a processing element for which to generate a cost model and/or variant. For example, the processing element may be one of the CPU 316, the FPGA 318, the VPU 320, or the GPU 322. The variant manager 402 may additionally select an aspect of the selected processing element to target for a success function. For example, during a training phase, the variant manager 402 may select power consumption of the GPU 322 to target for a success function associated with the GPU 322. During an inference phase, the variant manager 402 may select an aspect associated with a predetermined success function provided by a user (e.g., a developer); however, the variant manager 402 may additionally select multiple aspects to target in order to provide a runtime scheduler (e.g., the runtime scheduler 314) with a variety of variants to choose from based on the performance characteristics of a heterogeneous system.

In the example of FIG. 4, once a variant has been generated and meets a performance threshold associated with the success function, the variant manager 402 may determine whether there are any additional aspects of the selected processing element to target, whether there are additional processing elements to generate variants for, and/or whether there are any additional algorithms with which to train the cost model learner 404. If there are additional aspects, additional processing elements, and/or additional algorithms, the variant manager 402 may repeat the above actions. However, if there are not additional aspects, additional processing elements, and additional algorithms, the variant manager 402 may output the weights associated with the respective trained ML/AI models corresponding the respective processing elements of a heterogeneous system.

In the example of FIG. 4, the cost model learner 404 implements ML/AI techniques to generate trained ML/AI models associated with generating applications to be run on a heterogeneous system. For example, the cost model learner 404 can be a machine learning modeler. In examples disclosed herein, the cost model learner 404 implements a supervised DNN to learn an improve cost models associated with processing elements. However, in other examples, the cost model learner 404 may implement any suitable ML/AI model with supervised and/or unsupervised learning. In examples disclosed herein, the cost model learner 404 implements a DNN for each processing element of a heterogeneous system.

In some example, the example cost model learner 404 implements example means for generating trained ML/AI models that are associated with generating applications to be run on a heterogeneous system. The generating means is implemented by executable instruction such as that implemented by at least block 508 of FIG. 5 and block 608 of FIG. 6, which may be executed on at least one processor such as the example processor 812 shown in the example of FIG. 8. In other examples, the generating means is implemented by hardware logic, hardware implemented state machines, logic circuitry, and/or any other combination of hardware, software, and/or firmware.

In the example of FIG. 4, the weight storage 406 is a memory where the weights associated with one or more cost models for the respective processing elements of a heterogeneous system. The weights are stored in a file structure where each cost model has a respective weight file. The weight files may be read during a compilation auto-scheduling event and when the variant manager 402 outputs the trained ML/AI model. Additionally, weights may be written to the weight files after the cost model learner 404 generates a cost model.

In the example illustrated in FIG. 4, the compilation auto-scheduler 408 generates a schedule associated with the algorithm for the selected processing element based on the cost model (e.g., the weight file) generated by the cost model learner 404. In examples disclosed herein, the compilation auto-scheduler 408 generates a schedule through the use of auto-tuning. In other examples, any suitable auto-scheduling method may be used to generate a schedule associated with the algorithm for the selected processing element.

In some examples, the example compilation auto-scheduler 408 implements example means for scheduling algorithms for a selected processing element based on a cost model. The scheduling means is implemented by executable instruction such as that implemented by at least block 510 of FIG. 5 and block 610 of FIG. 6, which may be executed on at least one processor such as the example processor 812 shown in the example of FIG. 8. In other examples, the scheduling means is implemented by hardware logic, hardware implemented state machines, logic circuitry, and/or any other combination of hardware, software, and/or firmware.

In the illustrated example of FIG. 4, the variant compiler 410 compiles the schedule generated by the compilation auto-scheduler 408. For example, the variant compiler 410 compiles the algorithm into a method, class, or object that can be called by an executable application. After compiling the variant, the variant compiler 410, transmits the variant to an application to be compiled. Additionally, the variant compiled by the variant compiler 410 is transmitted to the jump table 412.

In some examples, the example variant compiler 410 implements example means for variant compiling to compile schedules generated by a compilation auto-scheduler. The variant compiling means is implemented by executable instruction such as that implemented by at least block 512 of FIG. 5 and blocks 612, 614, and 616 of FIG. 6, which may be executed on at least one processor such as the example processor 812 shown in the example of FIG. 8. In other examples, the variant compiling means is implemented by hardware logic, hardware implemented state machines, logic circuitry, and/or any other combination of hardware, software, and/or firmware.

In the example of FIG. 4, the jump table 412 associates the different variants generated by the variant compiler 410 with a location where the respective variants will be located in an executable application (e.g., a fat binary). For example, the jump table 412 associates the different variants with their respective location in an executable application via a variant symbol (e.g., a pointer) that points to the location of the respective variant in the executable application.

In some examples, the example jump table 412 implements example means for variant symbol storing to associate different variants with a location where the respective variants will be located in an executable application. The variant symbol storing means is implemented by executable instruction such as that implemented by at least block 622 of FIG. 6, which may be executed on at least one processor such as the example processor 812 shown in the example of FIG. 8. In other examples, the variant symbol storing means is implemented by hardware logic, hardware implemented state machines, logic circuitry, and/or any other combination of hardware, software, and/or firmware.

In the example of FIG. 4, the application compiler 414 compiles the algorithms, respective variants, variant symbols, and a runtime scheduler (e.g., the runtime scheduler 314) into executable applications for storage. The application compiler 414 compiles the algorithms, respective variants, and the runtime scheduler as a compiled version of the original algorithm (e.g., code) received by the variant generator 302. For example, if the algorithm is written in C/C++, the application compiler 414 compiles the algorithm, the respective variants, variant symbols, and a runtime scheduler into an executable C/C++ application that includes the variants written in their respective languages for execution on respective processing elements. In examples disclosed herein, the executable applications compiled by application compiler 414 are fat binaries. However, in other examples, the executable application compiled by the application compiler 414 may be any suitable executable file.

In some examples, the example application compiler 414 implements example means for compiling algorithms, variants, respective variant symbols, and a runtime scheduler into executable applications for storage. The compiling means is implemented by executable instruction such as that implemented by at least block 624 of FIG. 6, which may be executed on at least one processor such as the example processor 812 shown in the example of FIG. 8. In other examples, the compiling means is implemented by hardware logic, hardware implemented state machines, logic circuitry, and/or any other combination of hardware, software, and/or firmware.

In the example illustrated in FIG. 4, the feedback interface 416 is a device that interfaces between executable applications (e.g., fat binaries) running on a heterogeneous system and/or a storage facility (e.g., the database 208). For example, the feedback interface 416 may be a network interface, a USB port interface, ethernet port interface, or a serial port interface. During a training phase, the feedback interface 416 collects performance characteristics associated with a selected processing element. In a training phase, the collected performance characteristics correspond to power consumption of the selected processing element, time to run on the selected processing element, and other performance characteristics associated with the selected processing element.

In some examples, the example feedback interface 416 implements example means for interfacing between executable applications (e.g., fat binaries) running on a heterogeneous system and/or a storage facility. The interfacing means is implemented by executable instruction such as that implemented by at least blocks 514, 526, and 528 of FIG. 5, which may be executed on at least one processor such as the example processor 812 shown in the example of FIG. 8. In other examples, the interfacing means is implemented by hardware logic, hardware implemented state machines, logic circuitry, and/or any other combination of hardware, software, and/or firmware.

In the example of FIG. 4, during an inference phase, the feedback interface 416 is configured to collect performance characteristics and the performance delta associated with the system wide success function. The feedback interface 416 may collect the performance characteristics directly from an application executing on a heterogeneous system and/or from a storage device exterior to the heterogeneous system.

In the example of FIG. 4, the performance analyzer 418 identifies and analyzes received data (e.g., performance characteristics). During a training phase, the performance analyzer 418 determines whether the selected variant met a performance threshold. Moreover, during a training phase, the performance analyzer 418 analyzes the performance of a processing element to meet a success function. During the initial training phase, the performance analyzer 418 analyzes the performance of an individual processing element in isolation and does not consider the overall context of the processing elements in a heterogeneous system. This analysis is fed back into the cost model learner 404 to assist the DNN in analyzing and developing a more accurate cost model for the particular processing element.

In some examples, the example performance analyzer 418 implements example means for analyzing received and/or otherwise obtained data. The analyzing means is implemented by executable instruction such as that implemented by at least blocks 516, 530, and 532 of FIG. 5, which may be executed on at least one processor such as the example processor 812 shown in the example of FIG. 8. In other examples, the analyzing means is implemented by hardware logic, hardware implemented state machines, logic circuitry, and/or any other combination of hardware, software, and/or firmware.

After the trained model is output for use (e.g., use by a developer), the performance analyzer 418, after receiving an indication that input data (e.g., runtime characteristics on an heterogeneous system under load) has been received (e.g., an indication from the feedback interface 416), the performance analyzer 418 identifies an aspect of the heterogeneous system to target based on the success function of the system and the performance characteristics. Additionally, the performance analyzer 418 determines the difference between the desired performance (e.g., a performance threshold) defined by the success function and the actual performance achieved during execution of the algorithm during the inference phase.

In the example of FIG. 4, during a subsequent training phase, the additional empirical data obtained by the feedback interface 416 and utilized by the performance analyzer 418 may be re-inserted into the cost model learner 404 to adjust the cost models of the individual processing element based on the contextual data associated with the system as a whole (e.g., the performance characteristics, such as, runtime load and environment characteristics).

In the illustrated example of FIG. 4, based on this data the cost model learner 404 may take a variety of actions associated with the different cost models for the respective processing elements. For example, based on the collected empirical data, the cost model learner 404 may adjust the cost models of the respective processing elements so that the compilation auto-scheduler 408 will generate schedules, utilizing the adjusted cost models, that will perform a specified workload in a more desirable way. Additionally, if the performance characteristics indicate that a particular variant is infrequently selected, this will indicate to the performance analyzer 418 that variants targeting the particular aspect associated with that variant are not satisfactory candidates for workload offloading during runtime. Based on this information the performance analyzer 418 may indicate to the variant manager 402 to not generate variants for the associated aspect and/or associated processing element. This ultimately saves space on the application (e.g., the fat binary) generated by the application compiler 414 and reduces the memory consumed by the application when stored in memory.

In the example of FIG. 4, when utilizing the collected empirical data, the cost model learner 404 may additionally utilize additional DNNs to generate multiple cost models associated with a specific processing element. Each cost model may be focused on a specific aspect of a specific processing element, and at runtime, a runtime scheduler (e.g., the runtime scheduler 314) can choose from a variety of variants to be used on the heterogeneous system. For example, if an overall system success function is associated with conserving power, a runtime scheduler would typically utilize variants on all processing elements that are targeted at reducing power consumption. However, when comprehending the overall system performance under a runtime execution (e.g., by collecting empirical data), the cost model learner 404 may generate multiple variants targeting at least reducing power consumption and improving speed. At runtime, a runtime scheduler, implementing the examples disclosed herein, may determine that even executing a variant targeting improved speed is still within the bounds of the success function associated with conserving power. This improves the performance of an overall heterogeneous system while still maintaining the functionality to satisfy the desired success function.

While an example manner of implementing the variant generator 302 of FIG. 3 is illustrated in FIG. 4 and an example manner of implementing the executable 308 is shown in FIG. 3, one or more of the elements, processes and/or devices illustrated in FIG. 3 and FIG. 4 may be combined, divided, re-arranged, omitted, eliminated and/or implemented in any other way. Further, the example variant manager 402, the example cost model learner 404, the example weight storage 406, the example compilation auto-scheduler 408, the example variant compiler 410, the example jump table 412, the example application compiler 414, the example feedback interface 416, the example performance analyzer 418 and/or, more generally, the example variant generator 302 of FIG. 3 and/or the example variant library 310, the example jump table library 312, the example runtime scheduler 314 and/or more generally, the example executable 308 of FIG. 3 may be implemented by hardware, software, firmware and/or any combination of hardware, software and/or firmware. Thus, for example, any of the example variant manager 402, the example cost model learner 404, the example weight storage 406, the example compilation auto-scheduler 408, the example variant compiler 410, the example jump table 412, the example application compiler 414, the example feedback interface 416, the example performance analyzer 418 and/or, more generally, the example variant generator 302 and/or the example variant library 310, the example jump table library 312, the example runtime scheduler 314 and/or more generally, the example executable 308 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example variant manager 402, the example cost model learner 404, the example weight storage 406, the example compilation auto-scheduler 408, the example variant compiler 410, the example jump table 412, the example application compiler 414, the example feedback interface 416, the example performance analyzer 418 and/or, more generally, the example variant generator 302 and/or the example variant library 310, the example jump table library 312, the example runtime scheduler 314 and/or more generally, the example executable 308 of FIG. 3 is/are hereby expressly defined to include a non-transitory computer readable storage device or storage disk such as a memory, a digital versatile disk (DVD), a compact disk (CD), a Blu-ray disk, etc. including the software and/or firmware. Further still, the example variant generator 302 of FIG. 3 and/or the example executable 308 may include one or more elements, processes and/or devices in addition to, or instead of, those illustrated in FIG. 3 and FIG. 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the variant generator 302 of FIG. 3 is shown in FIGS. 5 and 6. The machine readable instructions may be one or more executable programs or portion(s) of an executable program for execution by a computer processor such as the processor 812 shown in the example processor platform 800 discussed below in connection with FIG. 8. The program may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example program is described with reference to the flowcharts illustrated in FIGS. 5 and 6, many other methods of implementing the example variant generator 302 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

Additionally, a flowchart representative of example hardware logic, machine readable instructions, hardware implemented state machines, and/or any combination thereof for implementing the executable 308 of FIG. 3 is shown in FIG. 7. The machine readable instructions may be one or more executable programs or portion(s) of an executable program for execution by a computer processor such as the processor 912 shown in the example processor platform 900 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowcharts illustrated in FIG. 7, many other methods of implementing the example executable 308 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

The machine readable instructions described herein may be stored in one or more of a compressed format, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5, 6, and 7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 is a flowchart representative of machine readable instructions 500 which may be executed to implement the variant generator 302 of FIGS. 3 and 4 in a training phase. The machine readable instructions 500 begin at block 502 where the variant manager 402 obtains an algorithm from an external device. For example, the external device is the administrator device 202 and the algorithm is an arbitrary algorithm in a set of arbitrary algorithms.

In the example of FIG. 5, at block 504, the variant manager 402 selects a particular processing element for which to develop the algorithm. For example, the variant generator 302 may be developing variants for use on a heterogeneous system including four processing elements. In such a scenario, the variant manager 402 selects one of the processing elements for which to generate a variant. At block 506, the variant manager 402 selects an aspect of the processing element to target for a success function of the selected processing element. For example, the variant manager 402 may select to target execution speed of the obtained algorithm on an FPGA.

In the illustrated example of FIG. 5, at block 508, the cost model learner 404 generates a cost model for the selected processing element and the select aspect to target. For example, on an initial run, the cost model learner 404 utilizes generic weights for a DNN to generate the cost model. At block 510, the compilation auto-scheduler 408 generates a schedule to implement the obtained algorithm with a success function associated with the selected aspect on the selected processing element. At block 512, the variant compiler 410 compiles a variant according to the schedule generated by the compilation auto-scheduler 408. The compiled variant is then loaded into an application that is compiled by the application compiler 414 as an executable file (e.g., a binary).

In the example of FIG. 5, at block 514, after the variant is subsequently executed on a training system (e.g., a training heterogeneous system), the feedback interface 416 collects performance characteristics associated with the performance of the variant on the selected processing element. At block 516, the performance analyzer 418 determines whether the execution of the variant meets a performance threshold. If the execution of the variant does not meet the performance threshold (e.g., a desired performance level) (block 516: NO), the machine readable instructions 500 proceed to block 508 where the collected performance characteristics are fed back into the cost model learner 404. If the execution of the variant meets the performance threshold (block 516: YES), the machine readable instructions 500 proceed to block 518.

In the illustrated example of FIG. 5, at block 518, the variant manager 402 determines whether there are any other aspects are to be targeted for success functions for the selected processing element. If there are subsequent aspects to target for success functions (block: 518: YES), the machine readable instructions 500 proceed to block 506. If there are not subsequent aspects to target for success functions (block: 518: NO), the machine readable instructions 500 proceed to block 520.

In the illustrated example of FIG. 5, at block 520, the variant manager 402 determines whether there are any other processing elements for which to develop one or more variants for. If there are subsequent processing elements (block: 520: YES), the machine readable instructions 500 proceed to block 504. If there are not subsequent processing elements (block: 520: NO), the machine readable instructions 500 proceed to block 522.

In the example illustrated in FIG. 5, at block 522, the variant manager 402 determines whether there are additional algorithms. If there are additional algorithms (block: 522: YES), the machine readable instructions 500 proceed to block 502. If there are not additional algorithms (block: 522: NO), the machine readable instructions 500 proceed to block 524. For a algorithms to be executed on n processing elements that target m different aspects, the variant generator 302 generates a*n*m DNN to generate and analyze the various cost models.

In the example of FIG. 5, at block 524, the variant manager 402 outputs the respective trained DNN models corresponding the respective processing elements of a heterogeneous system (e.g., weight files) for use. For example, the variant manager 402 outputs the trained DNN models to a database, another variant generator, and/or a heterogeneous system in the field. At block 526, the feedback interface 416 monitors for input data. For example, the feedback interface 416 monitors a database, a heterogeneous system in the field, or other data sources that may provide empirically collected performance characteristics.

In the example of FIG. 5, at block 528, the feedback interface 416 determines whether input data has been received and/or otherwise obtained. If the feedback interface 416 determines that input data has not been received (block 528: NO), the machine readable instructions 500 proceed to block 526. If the feedback interface 416 determines that input data has been received (block 528: YES), the machine readable instructions 500 proceed to block 530.

In the illustrated example of FIG. 5, at block 530, the performance analyzer 418 identifies an aspect of the heterogeneous system to target based on the success function of the system and the performance characteristics. At block 532, the performance analyzer 418 determines the difference between the desired performance (e.g., a performance threshold) defined by the success function and the actual performance achieved during execution of the algorithm during the inference phase. After block 530, the machine readable instructions 500 proceed to block 508 where the empirical data is re-inserted into the cost model learner 404 to adjust the cost models of the individual processing element based on the contextual data associated with the system as a whole (e.g., the performance characteristics, such as, runtime load and environment characteristics).

FIG. 6 is a flowchart representative of machine readable instructions 600 which may be executed to implement the variant generator 302 of FIGS. 3 and 4 during an inference phase. The machine readable instructions 600 begin at block 602 where the variant manager 402 obtains an algorithm from an external device. For example, the external device is a laptop computer of a program developer.

In the example of FIG. 6, at block 604, the variant manager 402 selects a particular processing element for which to develop the algorithm. For example, the variant generator 302 may be developing variants for use on a heterogeneous system including four processing elements. In such a scenario, the variant manager 402 selects one of the processing elements for which to generate a variant. At block 606, the variant manager 402 selects an aspect of the processing element to target for a success function of the selected processing element. For example, the variant manager 402 may select to target power consumption of execution of the obtained algorithm on an GPU.

In the illustrated example of FIG. 6, at block 608, the cost model learner 404 utilizes the trained DNN models to generate at least one cost model of the algorithm for execution on at least one processing element of a heterogeneous system. At block 610, the compilation auto-scheduler 408 generates a schedule to implement the obtained algorithm with a success function associated with the selected aspect on the selected processing element. At block 612, the variant compiler 410 compiles a variant according to the schedule generated by the compilation auto-scheduler 408.

In the example of FIG. 6, at block 614, the variant compiler 410 adds the variant to a variant library of the application to be compiled. At block 616, the variant compiler 410 adds a variant symbol (e.g., a pointer) to the jump table 412 by transmitting the variant to the jump table 412 which generates a corresponding symbol associated with the location of the variant in a variant library of the application to be compiled.

In the illustrated example of FIG. 6, at block 618, the variant manager 402 determines whether there are any other aspects are to be targeted for success functions for the selected processing element. If there are subsequent aspects to target for success functions (block: 618: YES), the machine readable instructions 600 proceed to block 606. If there are not subsequent aspects to target for success functions (block: 618: NO), the machine readable instructions 600 proceed to block 620.

In the illustrated example of FIG. 6, at block 620, the variant manager 402 determines whether there are any other processing elements for which to develop one or more variants for. If there are subsequent processing elements (block: 620: YES), the machine readable instructions 600 proceed to block 604. If there are not subsequent processing elements (block: 620: NO), the machine readable instructions 600 proceed to block 622.

In the example of FIG. 6, at block 622, the jump table 412 adds the current state of the jump table 412 to the jump table library of the application to be compiled. At block 624, the application compiler 414 compiles the different variants for the respective processing elements in the variant library, the variant symbols in the jump table library, and a runtime scheduler into an executable application.

In the example illustrated in FIG. 6, at block 626, the variant manager 402 determines whether there are additional algorithms. If there are additional algorithms (block: 626: YES), the machine readable instructions 600 proceed to block 602. If there are not additional algorithms (block: 626: NO), the machine readable instructions 600 end.

FIG. 7 is a flowchart representative of machine readable instructions 700 which may be executed to implement the executable 308 of FIG. 3. The machine readable instructions 700 begin at block 702 where the runtime scheduler 314 determines a system-wide success function for a heterogeneous system. At block 704, the runtime scheduler 314 executes the algorithm on a heterogeneous system according to variants generated by a trained ML/AI model. At block 706, the runtime scheduler 314 monitors the performance characteristics of the heterogenous system under a load and environmental conditions.

In the example of FIG. 7, at block 708, the runtime scheduler 314 adjusts the configuration of the heterogeneous system to meet the system-wide success function. For example, based on the performance characteristics, the runtime scheduler 314 may offload the workload executing on the CPU 316 to the GPU 322. To do so, the runtime scheduler 314 accesses a variant for the specific algorithm of the workload that corresponds to the GPU 322 that is stored in the variant library 310. The runtime scheduler 314 loads the variant onto the GPU 322 by accessing the respective variant symbol from the jump table library 312.

In the example illustrated in FIG. 7, at block 710, the runtime scheduler 314 determines whether the heterogeneous system includes persistent storage. If the runtime scheduler 314 determines that the heterogeneous system does include persistent storage (block 710: YES), the machine readable instructions 700 proceed to block 712 where the runtime scheduler 314 periodically stores the monitored data in the executable (e.g., the fat binary) on the persistent storage. After block 712, the machine readable instructions 700 proceed to block 724. If the runtime scheduler 314 determines that the heterogeneous system does not include persistent storage (block 710: NO), the machine readable instructions 700 proceed to block 714.

In the example of FIG. 7, at block 714, the runtime scheduler 314 determines whether the heterogeneous system includes flash storage. If the runtime scheduler 314 determines that the heterogeneous system does include flash storage (block 714: YES), the machine readable instructions 700 proceed to block 716 where the runtime scheduler 314 periodically stores the monitored data in the executable (e.g., the fat binary) on the flash storage. After block 716, the machine readable instructions 700 proceed to block 724. If the runtime scheduler 314 determines that the heterogeneous system does not include flash storage (block 714: NO), the machine readable instructions 700 proceed to block 718.

In the example illustrated in FIG. 7, at block 718, the runtime scheduler 314 determines whether the heterogeneous system includes persistent storage. If the runtime scheduler 314 determines that the heterogeneous system does include persistent BIOS (block 718: YES), the machine readable instructions 700 proceed to block 720 where the runtime scheduler 314 periodically stores the monitored data in the executable (e.g., the fat binary) on the persistent BIOS. After block 720, the machine readable instructions 700 proceed to block 724. If the runtime scheduler 314 determines that the heterogeneous system does not include persistent storage (block 718: NO), the machine readable instructions 700 proceed to block 722.

In the example of FIG. 7, at block 722, the runtime scheduler 314 transmits the monitored data (e.g., the empirical performance characteristics) to an external storage (e.g., the database 208). At block 724, the runtime scheduler 314 determines whether the algorithm has finished executing. If the runtime scheduler 314 determines that the algorithm has not finished executing (block 724: NO), the machine executable instructions 700 proceed to block 706. If the runtime scheduler 314 determines that the algorithm has finished executing (block 724: YES), the machine executable instructions 700 proceed to block 726.

In the example of FIG. 7, at block 726, the runtime scheduler 314 transmits the monitored data (e.g., the empirical performance characteristics) to an external device (e.g., the database 208, the variant generator 302, etc.). At block 728, the runtime scheduler 314 determines whether there are additional algorithms. If there are additional algorithms (block: 728: YES), the machine readable instructions 700 proceed to block 702. If there are not additional algorithms (block: 728: NO), the machine readable instructions 700 end.

FIG. 8 is a block diagram of an example processor platform 800 structured to execute the instructions of FIGS. 5 and 6 to implement the variant generator 302 of FIGS. 3 and 4. The processor platform 800 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example variant manager 402, the example cost model learner 404, the example weight storage 406, the example compilation auto-scheduler 408, the example variant compiler 410, the example jump table 412, the example application compiler 414, the example feedback interface 416, and the example performance analyzer 418.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5 and 6 may be stored in the mass storage device 828, in the volatile memory 814, in the non-volatile memory 816, and/or on a removable non-transitory computer readable storage medium such as a CD or DVD.

FIG. 9 is a block diagram of an example processor platform 900 structured to execute the instructions of FIG. 7 to implement the executable 308 of FIG. 3. The processor platform 900 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. Additionally, the processor platform 900 may include additional processing elements such as, the example CPU 316, the example FPGA 318, the example VPU 320, and the example GPU 322.

The processor 912 of the illustrated example includes a local memory 913 (e.g., a cache). In this example, the local memory 913 includes the example variant library 310, the example jump table library 312, the example runtime scheduler 314, and/or more generally the example executable 308. The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuit 920. The input device(s) 922 permit(s) a user to enter data and/or commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

The machine executable instructions 932 of FIG. 7 may be stored in the mass storage device 928, in the volatile memory 914, in the non-volatile memory 916, and/or on a removable non-transitory computer readable storage medium such as a CD or DVD.

From the foregoing, it will be appreciated that example methods, apparatus and articles of manufacture have been disclosed that examples disclosed herein do not rely solely on theoretical understanding of processing elements, developer knowledge of algorithm transformations and other scheduling techniques, and the other pitfalls of some methods for compilation scheduling. The examples disclosed herein collect empirical performance characteristics as well as the difference between the desired performance (e.g., a success function) and the actual performance attained. Additionally, the examples disclosed herein allow for the continuous and automated performance improvement of a heterogeneous system without developer intervention. The disclosed methods, apparatus and articles of manufacture improve the efficiency of using a computing device by at least reducing the power consumption of an algorithm executing on a computing device, increasing the speed of execution of an algorithm on a computing device, and increasing the usage of the various processing elements of a computing system. The disclosed methods, apparatus and articles of manufacture are accordingly directed to one or more improvement(s) in the functioning of a computer.

Example methods, apparatus, systems, and articles of manufacture to improve runtime performance of software executing on a heterogeneous system are disclosed herein. Further examples and combinations thereof include the following: Example 1 includes an apparatus to improve runtime performance of software executing on a heterogeneous system, the apparatus comprising a feedback interface to collect a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element, a performance analyzer to determine a performance delta based on the performance characteristic and the function, and a machine learning modeler to, prior to a second runtime, adjust a cost model of the first processing element based on the performance delta, the adjusted cost model to cause a reduction in the performance delta to improve runtime performance of the heterogeneous system.

Example 2 includes the apparatus of example 1, wherein the cost model is a first cost model generated based on a first neural network, the machine learning modeler to, prior to the second runtime, adjust a second cost model of the second processing element based on the performance delta, the second cost model generated based on a second neural network.

Example 3 includes the apparatus of example 1, wherein the compiled version is a first compiled version, the apparatus further including a compiler to, prior to the second runtime, compile the block of code into a second compiled version of the block of code, the second compiled version to be executed on the heterogenous system.

Example 4 includes the apparatus of example 1, wherein the feedback interface is to collect the performance characteristic from a runtime scheduler as a fat binary.

Example 5 includes the apparatus of example 4, wherein the performance characteristic is stored in a data-section of the fat binary.

Example 6 includes the apparatus of example 1, wherein the performance characteristic includes metadata and metric information associated with the execution of the compiled version of the block of code.

Example 7 includes the apparatus of example 1, wherein the performance analyzer is to determine the performance delta as a difference between performance achieved at the first runtime and performance as defined by the function designating successful execution of the compiled version on the heterogeneous system.

Example 8 includes a non-transitory computer readable storage medium comprising instructions which, when executed, cause at least one processor to at least collect a performance characteristic of a heterogeneous system associated with a compiled version of a block of code at a first runtime, the compiled version executed according to a function designating successful execution of the compiled version on the heterogeneous system, the heterogeneous system including a first processing element and a second processing element different than the first processing element, determine a performance delta based on the performance characteristic and the function, and prior to a second runtime, adjust a cost model of the first processing element based on the performance delta, the adjusted cost model to cause a reduction in the performance delta to improve runtime performance of the heterogeneous system.

Example 9 includes the non-transitory computer readable storage medium of example 8, wherein the cost model is a first cost model generated based on a first neural network, and wherein the instructions, when executed, cause the at least one processor to, prior to the second runtime, adjust a second cost model of the second processing element based on the performance delta, the second cost model generated based on a second neural network.

Example 10 includes the non-transitory computer readable storage medium of example 8, wherein the compiled version is a first compiled version, and wherein the instructions, when executed, cause the at least one processor to, prior to the second runtime, compile the block of code into a second compiled version of the block of code, the second compiled version to be executed on the heterogenous system.

Example 11 includes the non-transitory computer readable storage medium of example 8, wherein the instructions, when executed, cause the at least one processor to collect the performance characteristic from a runtime scheduler as a fat binary.

Example 12 includes the non-transitory computer readable storage medium of example 11, wherein the performance characteristic is stored in a data-section of the fat binary.

Example 13 includes the non-transitory computer readable storage medium of example 8, wherein the performance characteristic includes metadata and metric information associated with the execution of the compiled version of the block of code.

Example 14 includes the non-transitory computer readable storage medium of example 8, wherein the instructions, when executed, cause the at least one processor to determine the performance delta as a difference between performance achieved at the first runtime and performance as defined by the function designating successful execution of the compiled version on the heterogeneous system.

Example 15 includes an apparatus to improve runtime performance of software executing on a heterogeneous system, the apparatus comprising means for collecting, the means for collecting to collect a performance characteristic of a heterogeneous system associated with a compiled version of a block of code at a first runtime, the compiled version executed according to a function designating successful execution of the compiled version on the heterogeneous system, the heterogeneous system including a first processing element and a second processing element different than the first processing element, means for analyzing, the means for analyzing to determine a performance delta based on the performance characteristic and the function, and means for generating models, the means for generating models to, prior to a second runtime, adjust a cost model of the first processing element based on the performance delta, the adjusted cost model to cause a reduction in the performance delta to improve runtime performance of the heterogeneous system.

Example 16 includes the apparatus of example 15, wherein the cost model is a first cost model generated based on a first neural network, and wherein the means for generating models is to, prior to the second runtime, adjust a second cost model of the second processing element based on the performance delta, the second cost model generated based on a second neural network.

Example 17 includes the apparatus of example 15, wherein the compiled version is a first compiled version, further including means for compiled, the means for compiling to, prior to the second runtime, compile the block of code into a second compiled version of the block of code, the second compiled version to be executed on the heterogenous system.

Example 18 includes the apparatus of example 15, wherein the means for collecting are to collect the performance characteristic from a runtime scheduler as a fat binary.

Example 19 includes the apparatus of example 18, wherein the performance characteristic is stored in a data-section of the fat binary.

Example 20 includes the apparatus of example 15, wherein the performance characteristic includes metadata and metric information associated with the execution of the compiled version of the block of code.

Example 21 includes the apparatus of example 15, wherein the means for analyzing are to determine the performance delta as a difference between performance achieved at the first runtime and performance as defined by the function designating successful execution of the compiled version on the heterogeneous system.

Example 22 includes a method to improve runtime performance of software executing on a heterogeneous system, the method comprising collecting a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element, determining a performance delta based on the performance characteristic and the function, and prior to a second runtime, adjusting a cost model of the first processing element based on the performance delta, the adjusted cost model to cause a reduction in the performance delta to improve runtime performance of the heterogeneous system.

Example 23 includes the method of example 22, wherein the cost model is a first cost model generated based on a first neural network, the method further including adjusting, prior to the second runtime, a second cost model of the second processing element based on the performance delta, the second cost model generated based on a second neural network.

Example 24 includes the method of example 22, wherein the compiled version is a first compiled version, the method further including compiling, prior to the second runtime, the block of code into a second compiled version of the block of code, the second compiled version to be executed on the heterogenous system.

Example 25 includes the method of example 22, wherein the performance characteristic is collected from a runtime scheduler as a fat binary.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus to improve runtime performance of software executing on a heterogeneous system, the apparatus comprising:
a feedback interface to collect a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element;
a performance analyzer to determine a performance delta based on the performance characteristic and the function; and
a machine learning modeler to, prior to a second runtime, adjust a cost model of the first processing element based on the performance delta, the adjusted cost model to cause a reduction in the performance delta to improve runtime performance of the heterogeneous system.

2. The apparatus of claim 1, wherein the cost model is a first cost model generated based on a first neural network, the machine learning modeler to, prior to the second runtime, adjust a second cost model of the second processing element based on the performance delta, the second cost model generated based on a second neural network.

3. The apparatus of claim 1, wherein the compiled version is a first compiled version, the apparatus further including a compiler to, prior to the second runtime, compile the block of code into a second compiled version of the block of code, the second compiled version to be executed on the heterogenous system.

4. The apparatus of claim 1, wherein the feedback interface is to collect the performance characteristic from a runtime scheduler as a fat binary.

5. The apparatus of claim 4, wherein the performance characteristic is stored in a data-section of the fat binary.

6. The apparatus of claim 1, wherein the performance characteristic includes metadata and metric information associated with the execution of the compiled version of the block of code.

7. The apparatus of claim 1, wherein the performance analyzer is to determine the performance delta as a difference between performance achieved at the first runtime and performance as defined by the function designating successful execution of the compiled version on the heterogeneous system.

8. A non-transitory computer readable storage medium comprising instructions which, when executed, cause at least one processor to at least:
collect a performance characteristic of a heterogeneous system associated with a compiled version of a block of code at a first runtime, the compiled version executed according to a function designating successful execution of the compiled version on the heterogeneous system, the heterogeneous system including a first processing element and a second processing element different than the first processing element;
determine a performance delta based on the performance characteristic and the function; and
prior to a second runtime, adjust a cost model of the first processing element based on the performance delta, the adjusted cost model to cause a reduction in the performance delta to improve runtime performance of the heterogeneous system.

9. The non-transitory computer readable storage medium of claim 8, wherein the cost model is a first cost model generated based on a first neural network, and wherein the instructions, when executed, cause the at least one processor to, prior to the second runtime, adjust a second cost model of the second processing element based on the performance delta, the second cost model generated based on a second neural network.

10. The non-transitory computer readable storage medium of claim 8, wherein the compiled version is a first compiled version, and wherein the instructions, when executed, cause the at least one processor to, prior to the second runtime, compile the block of code into a second compiled version of the block of code, the second compiled version to be executed on the heterogenous system.

11. The non-transitory computer readable storage medium of claim 8, wherein the instructions, when executed, cause the at least one processor to collect the performance characteristic from a runtime scheduler as a fat binary.

12. The non-transitory computer readable storage medium of claim 11, wherein the performance characteristic is stored in a data-section of the fat binary.

13. The non-transitory computer readable storage medium of claim 8, wherein the performance characteristic includes metadata and metric information associated with the execution of the compiled version of the block of code.

14. The non-transitory computer readable storage medium of claim 8, wherein the instructions, when executed, cause the at least one processor to determine the performance delta as a difference between performance achieved at the first runtime and performance as defined by the function designating successful execution of the compiled version on the heterogeneous system.

15. An apparatus to improve runtime performance of software executing on a heterogeneous system, the apparatus comprising:
means for collecting, the means for collecting to collect a performance characteristic of a heterogeneous system associated with a compiled version of a block of code at a first runtime, the compiled version executed according to a function designating successful execution of the compiled version on the heterogeneous system, the heterogeneous system including a first processing element and a second processing element different than the first processing element;
means for analyzing, the means for analyzing to determine a performance delta based on the performance characteristic and the function; and
means for generating models, the means for generating models to, prior to a second runtime, adjust a cost model of the first processing element based on the performance delta, the adjusted cost model to cause a reduction in the performance delta to improve runtime performance of the heterogeneous system.

16. The apparatus of claim 15, wherein the cost model is a first cost model generated based on a first neural network, and wherein the means for generating models is to, prior to the second runtime, adjust a second cost model of the second processing element based on the performance delta, the second cost model generated based on a second neural network.

17. The apparatus of claim 15, wherein the compiled version is a first compiled version, further including means for compiling, the means for compiling to, prior to the second runtime, compile the block of code into a second compiled version of the block of code, the second compiled version to be executed on the heterogenous system.

18. The apparatus of claim 15, wherein the means for collecting are to collect the performance characteristic from a runtime scheduler as a fat binary.

19. The apparatus of claim 18, wherein the performance characteristic is stored in a data-section of the fat binary.

20. The apparatus of claim 15, wherein the performance characteristic includes metadata and metric information associated with the execution of the compiled version of the block of code.

21. The apparatus of claim 15, wherein the means for analyzing are to determine the performance delta as a difference between performance achieved at the first runtime and performance as defined by the function designating successful execution of the compiled version on the heterogeneous system.

22. A method to improve runtime performance of software executing on a heterogeneous system, the method comprising:
collecting a performance characteristic of the heterogeneous system associated with a compiled version of a block of code at a first runtime, the compiled version executed according to a function designating successful execution of the compiled version on the heterogeneous system, the heterogeneous system including a first processing element and a second processing element different than the first processing element;
determining a performance delta based on the performance characteristic and the function; and
prior to a second runtime, adjusting a cost model of the first processing element based on the performance delta, the adjusted cost model to cause a reduction in the performance delta to improve runtime performance of the heterogeneous system.

23. The method of claim 22, wherein the cost model is a first cost model generated based on a first neural network, the method further including adjusting, prior to the second runtime, a second cost model of the second processing element based on the performance delta, the second cost model generated based on a second neural network.

24. The method of claim 22, wherein the compiled version is a first compiled version, the method further including compiling, prior to the second runtime, the block of code into a second compiled version of the block of code, the second compiled version to be executed on the heterogenous system.

25. The method of claim 22, wherein the performance characteristic is collected from a runtime scheduler as a fat binary.
